(19) United States
(12) Patent Application Publication
(10) Pub. No.: US 2014/0252679 A1
(43) Pub. Date: Sep. 11, 2014

(54) LARGE-SCALE IMPRINT APPARATUS AND METHOD

(71) Applicants: Eun Soo HWANG, Seoul (KR); Eui Sun CHOI, Seoul (KR); Sung Hoon LEE, Seoul (KR)

(72) Inventors: Eun Soo HWANG, Seoul (KR); Eui Sun CHOI, Seoul (KR); Sung Hoon LEE, Seoul (KR)

(21) Appl. No.: 14/197,498

(22) Filed: Mar. 5, 2014

(30) Foreign Application Priority Data
Mar. 6, 2013 (KR) 10-2013-0023802

(51) Int. Cl. B29C 59/04

(52) U.S. Cl. CPC B29C 59/046
USPC 264/293; 425/112

(57) ABSTRACT

A large-scale imprint apparatus includes a roll-to-roll unit configured to wind or rewind a flexible substrate, a stage arranged adjacent to a winding path of the flexible substrate, the stage being configured to support a stamp master with a master pattern or to support a substrate, and a stamping pressing unit arranged adjacent to the stage, the stamping pressing unit being configured to press the flexible substrate against the stamp master or against the substrate.

### CROSS-REFERENCE TO RELATED APPLICATION

Korean Patent Application No. 10-2013-0023802, filed on Mar. 6, 2013, in the Korean Intellectual Property Office, and entitled: “Large-Scaled Imprint Apparatus and Method,” is incorporated by reference herein in its entirety.

### BACKGROUND

1. Field

Embodiments relate to a large-scale imprint apparatus and method, and more particularly, to a large-scale imprint apparatus and method by which a pattern may be formed on a substrate in a roll-to-roll method.

2. Description of the Related Art

Fine patterning technologies include photo lithography, laser interference lithography, scanning probe lithography (SPL), e-beam lithography, nano imprint, etc. The photolithography which uses light has a limit in diffraction of light, while the SPL and the e-beam lithography need a long time to create a pattern in a large area by a point scanning method. However, nano imprint is highlighted as a prospective technology that may embody high throughput and high resolution.

The nano imprint technology includes ultraviolet (UV) imprint, soft imprint, etc. According to the nano imprint technology, a nano pattern may be embodied by pressing a stamp (mold or template) having a nano pattern against a deformable polymer material, so that the deformable polymer material may have a shape opposite to the shape of the stamp, and curing the deformed polymer material.

### SUMMARY

The inventive concept provides a large-scale imprint apparatus and method which embodies uniform nano patterning, enables mass production, and facilitates handling and replacement of a film stamp, in spite of existence of surface unevenness, foreign materials on a surface, surface roughness, etc.

According to an aspect of embodiments, there is provided a large-scale imprint apparatus including a roll-to-roll unit configured to wind or rewind a flexible substrate, a stage arranged adjacent to a winding path of the flexible substrate, the stage being configured to support a stamp master with a master pattern or to support a substrate, and a stamping pressing unit arranged adjacent to the stage, the stamping pressing unit being configured to press the flexible substrate against the stamp master or against the substrate.

The stage may support the substrate, the stamping pressing unit may press the flexible substrate toward the substrate to form the pattern on a surface of the substrate, and the roll-to-roll module may wind the flexible substrate when the stamping pattern is replaced with another stamping pattern.

The stage may support the stamp master, the stamping pressing unit may press the flexible substrate toward the stamp master to form the stamping pattern on a surface of the flexible substrate, and the roll-to-roll module may wind the flexible substrate when the stamping pattern is formed at a position spaced apart from the stamping pattern of the flexible substrate.

The stamping pressing unit may include a flexible substrate pressing unit provided above the stage and allowing the flexible substrate to contact the stamp master or the substrate, and a sequential contact guide unit guiding the flexible substrate pressing unit to allow the flexible substrate to sequentially contact the stamp master or the substrate.

The flexible substrate pressing unit may include a pressing roller that presses the flexible substrate to allow the flexible substrate to sequentially contact the stamp master or the substrate.

The sequential contact guide unit may include a roller moving module moving the pressing roller along the flexible substrate, and a guide rail to which the pressing roller is coupled to be capable of relatively moving.

The roll-to-roll unit may include a substrate supply roll unit around which the flexible substrate is wound, and a substrate collecting roll unit arranged spaced apart from the substrate supply roll unit and winding or rewinding the flexible substrate with the substrate supply roll unit.

The roll-to-roll unit may further include a separation support unit that is arranged between the substrate supply roll unit and the substrate collecting roll unit and supports the flexible substrate to be spaced apart from the stamp master or the substrate.

The separation support unit may include an in-feed roll module guiding a movement of the flexible substrate from the substrate supply roll unit to the stamping pressing unit, and an out-feed roll module provided above the stage and guiding the flexible substrate toward the substrate collecting roll unit by supporting the flexible substrate to be spaced apart from the stamp master or the substrate.

The out-feed roll module may include a first separation support roller supporting an upper surface of the flexible substrate, and a second separation support roller arranged between the first separation support roller and the flexible substrate to be capable of accessing and being separated from first separation support roller, wherein the first separation support roller rotates to maintain a constant tension with respect to the flexible substrate even when the flexible substrate is moved in a pressing direction of the pressing roller while the pressing roller presses the flexible substrate toward the stamp master or the substrate.

The separation support unit may further include a return support module that supports the flexible substrate in an elastically biased state when the stamping pressing unit presses the flexible substrate to move toward the stamp master or the substrate.

The return support module may include a return support roller provided to be capable of moving from a normal position to a pressing position while the stamping pressing unit presses the flexible substrate toward the stamp master or the substrate, a plurality of support guide rollers provided adjacent to the return support roller and guiding a movement of the flexible substrate, and an elastic member coupled to the return support roller and providing an elastic force to return the return support roller to the normal position.

The roll-to-roll unit may further include a protection film removing unit that is provided adjacent to the substrate supply roll unit and removes a protection film of the flexible substrate pulled from the substrate supply roll unit.

The stage may be provided to be capable of moving from a coating position where resin is coated on the stamp master or the substrate toward the stamping pressing unit, and a coating unit for coating the resin may be provided at the coating position.

According to another aspect of embodiments, there is provided a large-scale imprint apparatus including a roll-to-roll unit for winding or rewinding a flexible substrate, a first stage arranged adjacent to a winding path of the flexible substrate and supporting stamp master where a master pattern for forming a stamping pattern on the flexible substrate is formed, a first stamping pressing unit arranged adjacent to the first stage and pressing the flexible substrate f to allow the flexible substrate and the stamp master to contact each other, thereby forming the stamping pattern on a surface of the flexible substrate, a second stage arranged spaced apart from the first stage and supporting the substrate that contacts the flexible substrate where the stamping pattern is formed so that a pattern is formed on the surface of the substrate, and a second stamping pressing unit arranged adjacent to the second stage and pressing the flexible substrate to allow the flexible substrate and the substrate to contact each other so that the pattern is formed on the surface of the substrate.

The roll-to-roll unit may wind the flexible substrate when the stamping pattern is replaced.

The first stamping pressing unit may include a first flexible substrate pressing unit provided above the stage and allowing the flexible substrate to sequentially contact the stamp master, and a first sequential contact guide unit guiding the first flexible substrate pressing unit to allow the flexible substrate to sequentially contact the stamp master. The second stamping pressing unit may include a second flexible substrate pressing unit provided above the stage and allowing the flexible substrate to contact the substrate; and a second sequential contact guide unit guiding the second flexible substrate pressing unit to allow the flexible substrate to sequentially contact the substrate.

The roll-to-roll unit may include a first separation support unit arranged between the substrate supply roll unit and the substrate collecting roll unit and supporting the flexible substrate to be spaced apart from the stamp master, and a second separation support unit arranged between the substrate supply roll unit and the substrate collecting roll unit and supporting the flexible substrate to be spaced apart from the substrate.

The second separation support unit may be arranged between the first stage and the second stage and comprises a middle in-feed roll module that guides a movement of the flexible substrate to the second stage.

According to another aspect of embodiments, there is provided a large-scale imprint method including coating resin on a substrate supported on a stage, and forming a pattern on a surface of the substrate by pressing a flexible substrate that is arranged to be capable of winding or rewinding, toward the substrate.

The forming of the pattern on the surface of the substrate may include pressing the flexible substrate toward the substrate to allow the flexible substrate to sequentially contact the substrate, and curing the resin.

The large-scale imprint method may further include winding the flexible substrate when the stamping pattern is replaced.

According to another aspect of embodiments, there is provided a large-scale imprint method including coating resin on a flexible substrate, and forming a stamping pattern on a surface of the flexible substrate by pressing the flexible substrate that is arranged to be capable of winding or rewinding, by using a stamp master having a surface where a master pattern is formed.

The forming of the stamping pattern on the surface of the flexible substrate may include pressing the flexible substrate by using the stamp master to allow the flexible substrate to sequentially contact the stamp master, and curing the resin.

The large-scale imprint method may further include winding the flexible substrate when the stamping pattern is newly formed.

According to another aspect of embodiments, a large-scale imprint apparatus includes a roll-to-roll unit configured to wind or rewind a flexible substrate, a first stage arranged below a winding path of the flexible substrate, the first stage being configured to support a stamp master or to substrate, and a first stamping pressing unit above the first stage and above the winding path of the flexible substrate, the stamping pressing unit being configured to press the flexible substrate against the stamp master or the substrate.

The first stamping pressing unit may include a flexible substrate pressing unit above the stage, and a sequential contact guide unit configured to move along the flexible substrate while pressing the flexible substrate against the stamp master or the substrate.

The roll-to-roll unit may include a substrate supply roll unit around which the flexible substrate is wound, a substrate collecting roll unit spaced apart from the substrate supply roll unit and winding or rewinding the flexible substrate with the substrate supply roll unit, and a separation support unit between the substrate supply roll unit and the substrate collecting roll unit, the separation support unit including a return support module configured to support the flexible substrate in an elastically biased state.

The stage may be moveable from a first position to a second position, the first position being below the first pressing unit and second position being below a coating unit.

The large-scale imprint apparatus may further include a second stage spaced apart from the first stage and supporting the substrate, the substrate being configured to contact a surface of the flexible substrate with a master pattern, and a second stamping pressing unit above the second stage and configured to press the flexible substrate against the substrate, wherein the first stage supports only the stamp master and the first stamping pressing unit is configured to press the flexible substrate only against the stamp master.

### BRIEF DESCRIPTION OF THE DRAWINGS

Features will become apparent to those of ordinary skill in the art by describing in detail exemplary embodiments with reference to the attached drawings, in which:

FIG. 1 illustrates a schematic view of a large-scale imprint apparatus according to an exemplary embodiment;

FIGS. 2A-2D illustrate schematic, perspective views of stages in a stamping process of manufacturing a stamping pattern on a flexible substrate by the imprint apparatus of FIG. 1;

FIGS. 3A-3D illustrate schematic, perspective views of stages in an imprint process of forming a pattern on a substrate by using the imprint apparatus of FIG. 1; and

FIG. 4 illustrates a schematic view of a large-scale imprint apparatus according to another exemplary embodiment.

### DETAILED DESCRIPTION

The attached drawings for illustrating embodiments are referred to in order to gain a sufficient understanding of the embodiments and the merits thereof. Like reference numerals in the drawings denote like elements.

Exemplary embodiments are described in detail with reference to the accompanying drawings. However, embodiments are not limited thereto, and it will be understood that various changes in form and details may be made therein without departing from the spirit and scope of the following claims. That is, descriptions of particular structures or functions may be presented merely for explaining exemplary embodiments.

The terms such as “first” and “second” are used herein merely to describe a variety of constituent elements, but the constituent elements are not limited by the terms. The terms are used only for the purpose of distinguishing one constituent element from another constituent element. For example, without departing from the right scope of the embodiments, a first constituent element may be referred to as a second constituent element, and vice versa.

In the present specification, when a constituent element “connects” or is “connected” to another constituent element, the constituent element contacts or is connected to the other constituent element directly or through at least one other constituent element. Conversely, when a constituent element is described to “directly connect” or to be “directly connected” to another constituent element, the constituent element should be construed to be directly connected to the other constituent element without any other constituent element interposed therebetween. Other expressions, such as, “between” and “directly between”, describing the relationship between the constituent elements, may be construed in the same manner.

The terms used in the present specification are used for explaining a specific exemplary embodiment, not for limiting embodiments. Thus, the expression of singularity in the present specification includes the expression of plurality unless clearly specified otherwise in context. Also, the terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless defined otherwise, all terms used herein including technical or scientific terms have the same meanings as those generally understood by those of ordinary skill in the art. The terms as those defined in generally used dictionaries are construed to have meanings matching that in the context of related technology and, unless clearly defined otherwise, are not construed to be ideally or excessively formal.

An imprint apparatus and method according to embodiments is used to form a pattern of a nano- or micro-level in a large area and may be used for, e.g., a semiconductor manufacturing/packaging process, a display manufacturing/packaging process, a solar cell or LED/OLED manufacturing/packaging process, and a medical diagnosis/treatment apparatus manufacturing process. Also, the imprint apparatus and method according to embodiments may be used to obtain a visual effect by using diffraction and reflection of light and a texture effect by using surface unevenness or selective surface processing through nano- or micro-level patterning of an outer surface of a material, e.g., plastic, metal, glass, etc., of a product, e.g., a vehicle, a home appliance, etc.

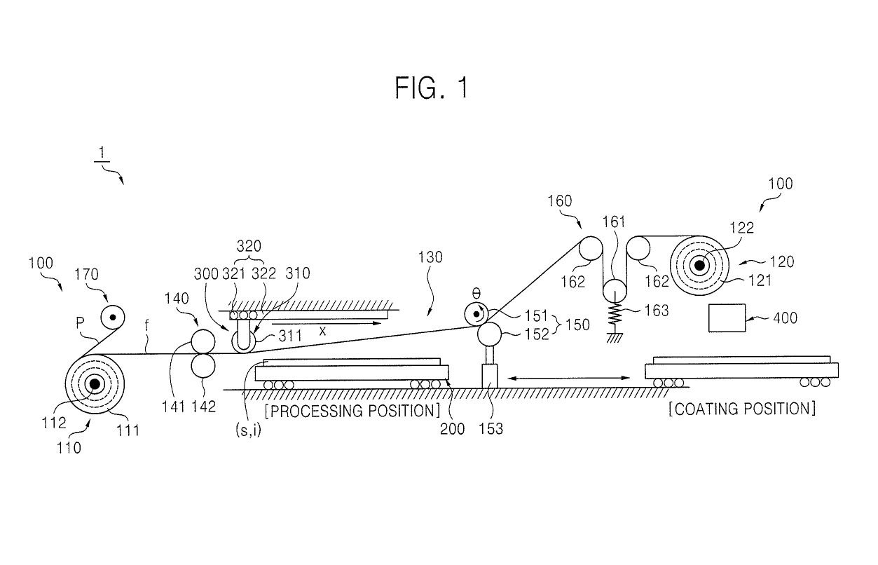

FIG. 1 illustrates a schematic view of a large-scale imprint apparatus 1 according to an exemplary embodiment. Referring to FIG. 1, the large-scale imprint apparatus 1 according to the present exemplary embodiment may include a roll-to-roll unit 100 for winding or rewinding a flexible substrate “f”, a stage 200 for supporting a stamp master “s” or a substrate “i”, a stamping pressing unit 300 for pressing the flexible substrate “f” to contact the stamp master “s” or the substrate “i”, and a coating unit 400 provided at a coating position where resin (not shown) is coated on the stamp master “s” or the substrate “i” and coating the resin.

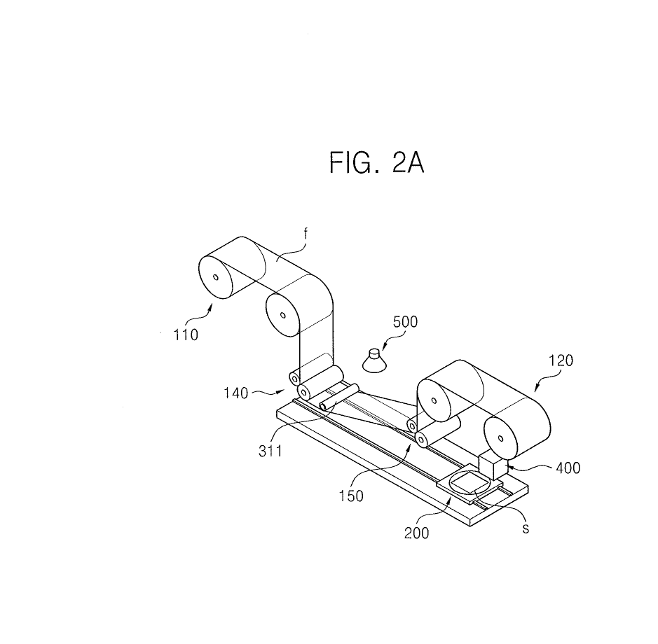

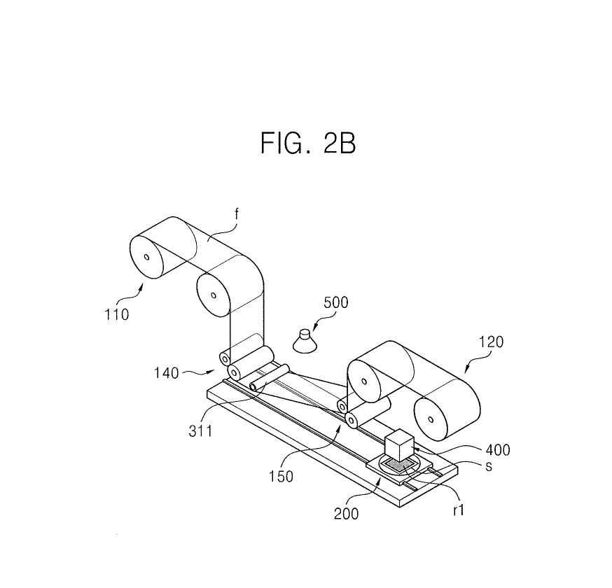

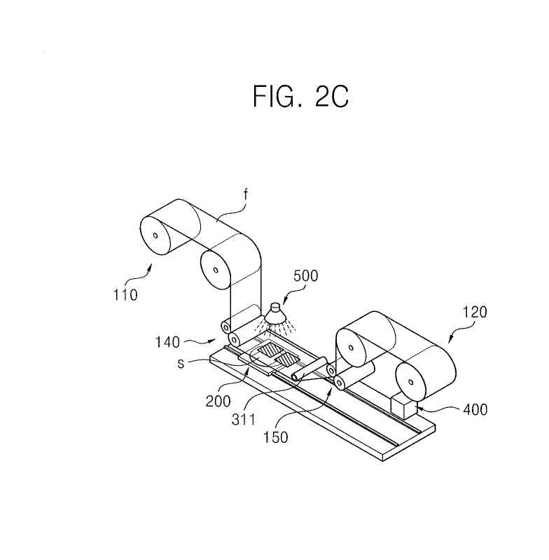

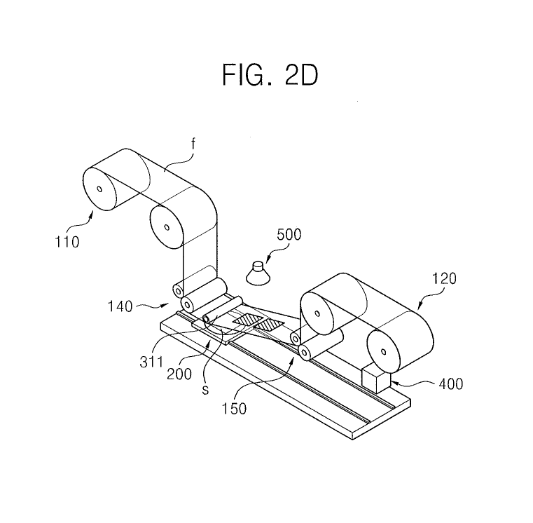

During a stamping process, in which a stamping pattern is formed on the flexible substrate “f” to manufacture the flexible substrate “f” as a film stamp, the stage 200 supports the stamp master “s” and the stamping pressing unit 300 presses the flexible substrate “f” toward the stamp master “s”, thereby forming a stamping pattern on a surface of the flexible substrate “f”. In doing so, a master pattern for forming the stamping pattern on the flexible substrate “f” is formed on the stamp master “s”, and the resin is coated on the surface of the stamp master “s”. During formation of the stamping pattern, when the stamping pressing unit 300 presses the flexible substrate “f” toward the stamp master “s”, the resin is cured by an ultraviolet (UV) lamp 500 (refer to FIGS. 2A to 2D).

When an additional stamping pattern is to be formed at a position spaced apart from a previous stamping pattern on the flexible substrate “f” during the stamping process, the roll-to-roll unit 100 winds the flexible substrate “f” by a predetermined distance, so the additional stamping pattern is formed on a new surface of the flexible substrate “f”. Accordingly, a film stamp may be easily manufactured.

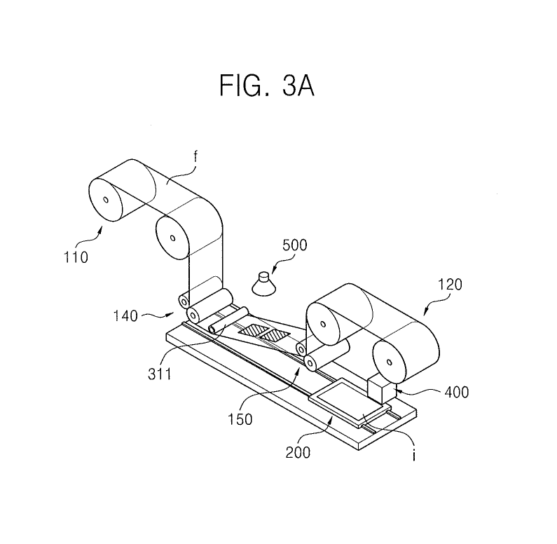

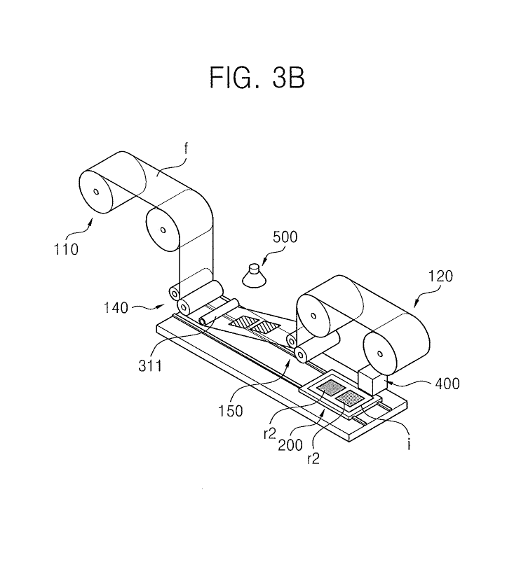

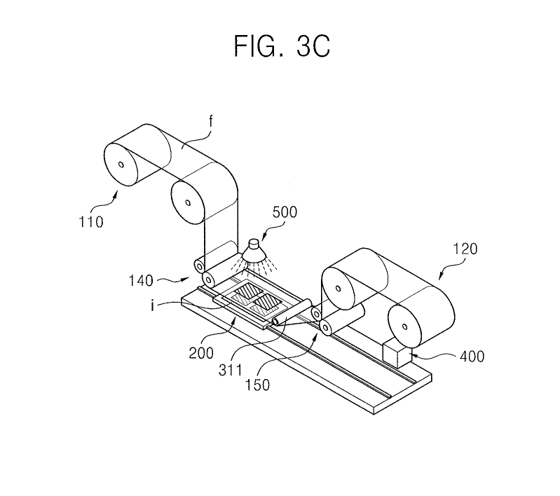

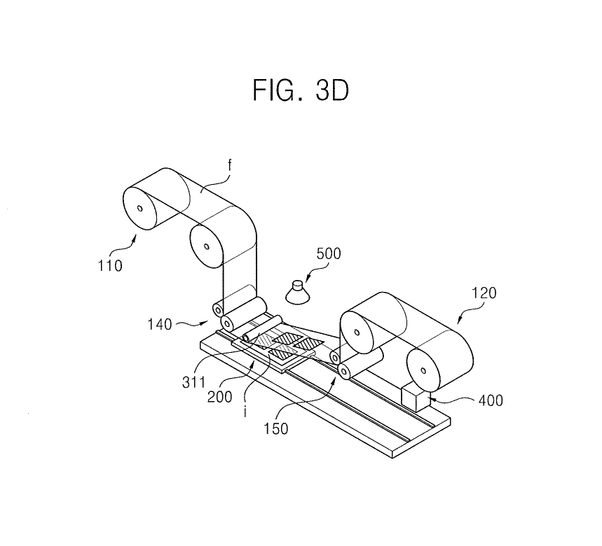

During an imprint process, in which a pattern is transferred to the substrate “i” by using the stamping pattern formed on the flexible substrate “f”, the stage 200 supports the substrate “i” and the stamping unit 300 presses the flexible substrate “f” against the substrate “i”, thereby transferring the stamped pattern from the flexible substrate “f” to the surface of the substrate “i”. The surface of the substrate “i” is coated with resin. When the pattern is formed on the substrate “i”, the resin is cured by the UV lamp 500 (refer to FIGS. 3A to 3D) in a state in which the stamping pressing unit 300 presses the flexible substrate “f” toward the substrate “i”.

When the stamping pattern is replaced to a new stamping pattern, while the process of forming a pattern on the surface of the substrate “i” during the imprint process is performed to a degree, the roll-to-roll unit 100 winds the flexible substrate “f” so that the new stamping pattern may be arranged above the stage 200 that performs the imprint process. Accordingly, the flexible substrate “f”, i.e., a film stamp, where the stamping pattern is formed may be easily replaced.

As such, the imprint apparatus 1 according to the present exemplary embodiment adopts a roll-to-roll method, in which the roll-or-roll unit 100 winds a film with a clean, e.g., smooth or unpatterned, surface or the flexible substrate “f” with a patterned surface, i.e., where a micro- or nano-level pattern is formed. Accordingly, in spite of surface unevenness, foreign materials on a surface, surface roughness, etc., uniform nano-patterning may be embodied and mass production may be possible. Also, the flexible substrate “f”, or a film stamp, having a stamping pattern formed thereon may be easily handled or replaced.

The flexible substrate “f” that is continuously supplied according to the present exemplary embodiment may be formed of, e.g., a polymer film of poly carbonate (PC), polyethylene terephthalate (PET), polyethylene naphthalene (PEN), polyimde (PI), etc., or thin glass, metal, etc. Also, the surface of the flexible substrate “f” may be deposited with a thin film, e.g., SiOₓ, SiN_{X}, etc., processed appropriately for the imprint process, or covered with a protection film P.

Referring to FIG. 1, in the large-scale imprint apparatus 1 according to an exemplary embodiment, the roll-to-roll unit 100 may include a substrate supply roll unit 110 having the flexible substrate “f” wound therearound, a substrate collecting roll unit 120 arranged spaced apart from the substrate supply roll unit 110 to wind or rewind the flexible substrate “f” with the substrate supply roll unit 110, a separation support unit 130 provided to guide a movement of the flexible substrate “f” toward the stage 200 and to support the flexible substrate “f” to be separated from the stamp master “s” or the substrate “i”, and a protection film removing unit 170 for removing the protection film P of the flexible substrate “f” released from the substrate supply roll unit 110.

The substrate supply roll unit 110 may include a winding roll 111 around which a film corresponding to the flexible substrate “f” may be wound and a winding rotation shaft 112 for rotating the winding roll 111. The winding rotation shaft 112 may be configured to transfer a rotational force that is angularly controlled.

The substrate collecting roll unit 120 may include a rewinding roll 121 around which a film corresponding to the flexible substrate “f” may be wound and a rewinding rotation shaft 122 for rotating the rewinding roll 121. The rewinding rotation shaft 122 may be configured to transfer a rotational force that is angularly controlled, e.g., like the winding rotation shaft 112.

According to the above configuration, the flexible substrate “f” is released from the substrate supply roll unit 110 and wound around the substrate collecting roll unit 120, thereby moving by a predetermined section. The separation support unit 130, the stage 200, and the stamping pressing unit 300 are arranged on a winding path of, e.g., to overlap, the flexible substrate “f”.

The protection film removing unit 170 is provided adjacent to the substrate supply roll unit 110 to remove the protection film P of the flexible substrate “f” released from the substrate supply roll unit 110. Accordingly, the protection film P attached to the flexible substrate “f” may be collected.

The separation support unit 130 is arranged between the substrate supply roll unit 110 and the substrate collecting roll unit 120 and supports the flexible substrate “f” to be spaced apart from the stamp master “s” or the substrate “i”. The separation support unit 130 may include an in-feed roll module 140 for guiding the flexible substrate “f” to move toward the stamping pressing unit 300 from the substrate supply roll unit 110, an out-feed roll module 150 for supporting the flexible substrate “f” to be spaced apart from the stamp master “s” or the substrate “i” and for guiding the flexible substrate “f” to move toward the substrate collecting roll unit 120, and a return support module 160 pressed by the stamping pressing unit 300 toward the stamp master “s” or the substrate “i” and supporting the flexible substrate “f” in an elastically biased state when a partial area of the flexible substrate “f” retreats.

The in-feed roll module 140 is provided at an entering side of the flexible substrate “f” with respect to the stage 200, i.e., the in-feed roll module 140 may be between the substrate supply roll unit 110 and the stage 200, and is at a height ensuring the flexible substrate “f” is spaced apart from the stamp master “s” or the substrate “i”. The in-feed roll module 140 may include an upper roller 141 and a lower roller 142 that are provided to be capable of rotating. A slip prevention element, e.g., a friction pad, to restrict slippage of the flexible substrate “f” may be provided on surfaces of the upper roller 141 and the lower roller 142. The in-feed roll module 140 separates a tension from the substrate supply roll unit 110 to the in-feed roll module 140 and a tension after the in-feed roll module 140.

According to the in-feed roll module 140 configured as above, the flexible substrate “f” disposed between the upper roller 141 and the lower roller 142 is prevented from being moved in the reverse direction, i.e., back toward the substrate supply roll unit 110, and is allowed to move, e.g., only, toward the stage 200. Therefore, the flexible substrate “f” may be moved toward the stage 200.

The out-feed roll module 150 maintains a constant tension between the in-feed roll module 140 to the out-feed roll module 150. In detail, when a pressing roller 311 of the stamping pressing unit 300 is moved in a direction X while the stage 200 remains stationary, i.e., without moving, the tension between the in-feed roll module 140 and the out-feed roll module 150 changes. Therefore, in order to maintain the tension between the in-feed roll module 140 and the out-feed roll module 150 constant, a first separation support roller 151 of the out-feed roll module 150, which will be described later, rotates in a direction θ according to a movement of the pressing roller 311 of the stamping pressing unit 300 so as to maintain the tension between the in-feed roll module 140 and the out-feed roll module 150, which is a process section, constant.

A tension meter may be further provided between the in-feed roll module 140 and the out-feed roll module 150. A signal of the tension meter may be used as a feedback signal for driving the out-feed roll module 150.

The out-feed roll module 150 may include the first separation support roller 151 and a second separation support roller 152 arranged between the first separation support roller 151 and the flexible substrate “f”. The second separation support roller 152 is configured to be separated and spaced apart from the first separation support roller 151, as will be described below.

As described above, when the pressing roller 311 moves in the direction X, while pressing the flexible substrate “f” toward the stamp master “s” or the substrate “i”, a partial area of the flexible substrate “f” may retreat, e.g., be pushed back, toward the pressing roller 311. However, the first separation support roller 151 of the out-feed roll module 150 rotates in the direction θ, thereby maintaining a constant predetermined tension with respect to the flexible substrate “f”.

When the flexible substrate “f” is to be moved toward the substrate collecting roll unit 120, while the stamping pattern of the flexible substrate “f” is not in contact with the second separation support roller 152, the second separation support roller 152 is maintained to be spaced apart from the first separation support roller 151, e.g., via a roller drive unit 153. To this end, the roller drive unit 153 may provide power and may control contact, e.g., access and/or separation, between the second separation support roller 152 and the first separation support roller 151. The roller drive unit 153 may be provided in a variety of types, e.g., a pneumatic cylinder.

The return support module 160 may support, e.g., keep, the flexible substrate “f” and supply the flexible substrate “f”, while the flexible substrate “f” is pressed by the pressing roller 311 toward the stamp master “s” or the substrate “i”. The return support module 160 may include a return support roller 161 provided to be capable of moving from an initial, i.e., normal, position to a pressing position, i.e., when the flexible substrate “f” is pressed by the stamping pressing unit 300 toward the stamp master “s” or the substrate “i”, a plurality of support guide rollers 162 provided adjacent to the return support roller 161 to guide the movement of the flexible substrate “f”, and an elastic member 163 coupled to the return support roller 161 and providing an elastic force to return the return support roller 161 to the normal position.

As described above, when the flexible substrate “f” is pressed by the stamping pressing unit 300, a partial area of the flexible substrate “f” may be moved toward the stage 200. When the partial area of the flexible substrate “f” is moved toward the stage 200, a remaining area, i.e., other area than the partial area, of the flexible substrate “f” is supported in a state of being elastically biased, e.g., inclined, by the return support roller 161. Accordingly, when the pressing of the flexible substrate “f” by the stamping pressing unit 300 is removed, the partial area of the flexible substrate “f” that is moved by the elastic member 163 may be returned to the original state, i.e., move away from the stage 200.

The return support roller 161 is provided to be capable of moving up and down by the pressing of the stamping pressing unit 300 against the flexible substrate “f”. In the present exemplary embodiment, the elastic member 163 is connected to a lower portion of the return support roller 161, e.g., the elastic member 163 may be a coil spring. However, embodiments are not limited thereto, e.g., the elastic member 163 may be connected to an upper portion of the return support roller 161 according to a state of the flexible substrate “f” wound around the return support roller 161. Alternatively, rather than a coil spring, the elastic member 163 may be connected to other devices that may provide a return force to the return support roller 161, e.g., an actuator (not shown) that may provide a force to move up and down, to move the flexible substrate “f” in the reverse direction and then allow the flexible substrate “f” to return.

The support guide rollers 162 may be provided at opposite sides of the return support roller 161 and at a same level, e.g., at a same height. Accordingly, after passing through the out-feed roll module 150, the flexible substrate “f” may be wound around the support guide roller 162 disposed at a first side of the return support roller 161, reversely wound around the return support roller 161, and then wound around the support guide roller 162 disposed at a second side of the return support roller 161, thereby moving toward the substrate collecting roll unit 120.

In the present exemplary embodiment, the out-feed roll module 150 and the return support module 160 are arranged to support, in cooperation with the in-feed roll module 140, the flexible substrate “f”, such that the flexible substrate “f” is higher than the in-feed roll module 140 at an escape side of the stage 200, i.e., a side that is opposite to the entering side of the flexible substrate “f” relative to the stage 200, and such that the flexible substrate “f” is spaced apart from the stamp master “s” or the substrate “i” of the stage 200. In other words, as illustrated in FIG. 1, the out-feed roll module 150 and the return support module 160 are arranged to have a portion of the flexible substrate “f” positioned between the stage 200 and the out-feed roll module 150 at a higher level than a portion of the flexible substrate “f” in the in-feed roll module 140 relatively to the stage 200.

Accordingly, the flexible substrate “f” is arranged at an incline, i.e., a distance between the flexible substrate “f” and an edge of the stage 200 adjacent to the in-feed roll module 140 may be smaller than a distance between the flexible substrate “f” and an edge of the stage 200 adjacent to out-feed roll module 150. As such, when the flexible substrate “f” is pressed by the stamping pressing unit 300 toward the stamp master “s” or the substrate “i”, the flexible substrate “f” does not contact directly the stamp master “s” or the substrate “i” but contacts the resin coated on the stamp master “s” or the substrate “i”.

According to the present exemplary embodiment, an apparatus for controlling the position of the flexible substrate “f” in a cross machine direction (CD), e.g., an edge position controller (EPC), a load cell for measuring a tension, an ionizer for removing particles, and a vision apparatus for measuring the position of a roll in a widthwise direction thereof through a mark on the flexible substrate “f” may be additionally provided in a section between the substrate supply roll unit 110 and the in-feed roll module 140 or between the in-feed roll module 140 and the out-feed roll module 150.

The stamping pressing unit 300 for pressing the flexible substrate “f” toward the stamp master “s” or the substrate “i” supported on the stage 200 may be provided on a winding path of the flexible substrate “f” that is continuously moved by the roll-to-roll unit 100, e.g., the stamping pressing unit 300 may be positioned between the in-feed roll module 140 and the out-feed roll module 150 to overlap the flexible substrate “f”. The stamping pressing unit 300 may include a flexible substrate pressing unit 310 provided above the stage 200 to allow the flexible substrate “f” to contact the stamp master “s” or the substrate “i” and a sequential contact guide unit 320 guiding the flexible substrate pressing unit 310 to allow the flexible substrate “f” to sequentially contact the stamp master “s” or the substrate “i”.

The flexible substrate pressing unit 310 may include the pressing roller 311 that presses the flexible substrate “f” toward the stamp master “s” or the substrate “i”. According to the present embodiment, the pressing roller 311 that is arranged in the widthwise direction of the flexible substrate “f” is moved by the sequential contact guide unit 320 in the winding direction of the flexible substrate “f”. Accordingly, the flexible substrate “f” continuously makes a linear contact with the stamp master “s” or the substrate “i”, thereby forming a pattern on the resin coated on the stamp master “s” or the substrate “i”.

In other words, the flexible substrate pressing unit 310 may be moved by the sequential contact guide unit 320 along the flexible substrate “f” to allow the flexible substrate “f” to sequentially, e.g., continuously, contact the stamp master “s” or the substrate “i”. Then, the flexible substrate pressing unit 310 may be returned to its original position by the sequential contact guide unit 320, so that the flexible substrate “f” may be separated from the stamp master “s” or the substrate “i”. It is noted, however, that although the flexible substrate pressing unit 310 includes the pressing roller 311, embodiments are not limited thereto, e.g., the flexible substrate pressing unit 310 may be configured to press the flexible substrate “f” to sequentially contact stamp master “s” or the substrate “i” by using air.

The sequential contact guide unit 320 includes a roller moving module 321 for moving the pressing roller 311 along the flexible substrate “f” and a guide rail 322 to which the pressing roller 311 is coupled to be capable of relatively moving. According to the above-described structure, the pressing roller 311 is moved by the roller moving module 321 along the guide rail 322 so as to sequentially press the flexible substrate “f” toward the stamp master “s” or the substrate “i”. After the pattern of the resin is cured, the pressing roller 311 may be returned by the roller moving module 321.

The roller moving module 321 according to the present embodiment may be a linear drive apparatus that is connected to the pressing roller 311 and linearly moves the pressing roller 311. Although it is not illustrated, the linear drive apparatus may include drive components, e.g., a lead screw and motor. Also, the linear drive apparatus may include a linear motor as a drive component that may provide a linear movement.

As illustrated in FIG. 1, the stage 200 is provided to be capable of moving from the coating position, i.e., where the resin is coated on the surface of the stamp master “s” or the substrate “i”, to a processing position, i.e., where the stamping pressing unit 300 is disposed. For example, the stage 200 is provided on a stage rail (not shown) to be capable of moving. The stage 200 is movable by a linear motor that maybe mounted on the stage rail. The stage 200 may include a stage chuck (not shown) where the stamp master “s” or the substrate “i” is fixed thereon. The stage chuck may perform alignment with respect to the master “s” or the substrate “i”.

The coating unit 400 for coating resin may be provided at the coating position. The coating unit 400 may coat resin for imprint on the master “s” or the substrate “i” by various coating or dispensing methods, e.g., ink-jetting, slot die costing, etc.

The large-scale imprint apparatus 1 according to the present exemplary embodiment of FIG. 1 may perform a film stamp process, i.e., process A, of manufacturing a stamping pattern on the flexible substrate “f” or an imprint process, i.e., process B, of forming a pattern on the flexible substrate “f”, according to an object supported on the stage 200.

FIGS. 2A-2D illustrate perspective views schematically illustrating the stamping process A of manufacturing a stamping pattern on the flexible substrate “f” by the large-scale imprint apparatus 1 of FIG. 1. FIGS. 3A-3D illustrate perspective views schematically illustrating the imprint process B of forming a pattern on the substrate “i” by using the large-scale imprint apparatus 1 of FIG. 1. As illustrated in FIGS. 2A-2D, when the film stamp process A of forming a stamping pattern on the flexible substrate “f” is performed, the stamp master “s”, having a master pattern for forming a stamping pattern on the flexible substrate “f”, is supported on the stage 200. As illustrated in FIGS. 3A-3D, when the imprint process B of forming a pattern on the substrate “i” is performed, the stamping pattern is already formed on the flexible substrate “f” and the substrate “i” is supported on the stage 200.

As illustrated in FIGS. 2A-2D, when the film stamp process A of forming a stamping pattern on the flexible substrate “f” is performed, a new flexible substrate “f” having no pattern is used (FIG. 2A). The new flexible substrate “f” is supported by the roll-to-roll unit 100, and the stamp master “s” having a surface coated with resin r1 at the coating position is supported on the stage 200 (FIG. 2B). Next, as illustrated in FIG. 2C, the stamp master “s” with the resin coating is moved to the processing position, and the stamping pressing unit 300 presses the flexible substrate “f” toward the stamp master “s” where a master pattern is formed, followed by curing of the resin r1 by the UV lamp 500 (FIG. 2C). As illustrated in FIG. 2D, the stamping pattern is formed on the flexible substrate “f”, which is moved toward the substrate collecting roll unit 120.

As illustrated in FIGS. 3A-3D, when the imprint process B of forming a pattern to the substrate “i” is performed, a stamped flexible substrate “f” is used (FIG. 3A). When the stamped flexible substrate “f” is supplied by the roll-to-roll unit 100, the substrate “i” having a surface coated with resin r2 at the coating position is supported on the stage 20 (FIG. 3B). Next, as illustrated in FIG. 3C, the substrate “i” with the resin coating is moved to the processing position, and the stamping pressing unit 300 presses the flexible substrate “f” against the coated substrate “i”, followed by curing via the UV lamp 500. As illustrated in FIG. 3D, the stamping pattern of the stamped flexible substrate “f” is transferred to the coated substrate “i”, and the stamped substrate “f” is lifted off the coated substrate “i”.

According to the present exemplary embodiment, the stamping process A of forming a stamping pattern on the flexible substrate “f” and the imprint process B of forming a pattern to the substrate “i” may be performed in the order of A-B-B-B-•• . . . ••••-B-A-B-B-B-•• . . . ••••-B-A-, according to the life span of the flexible substrate “f” where the stamping pattern is formed, i.e., a film stamp. In other words, a same film stamp may be used multiple times to imprint multiple substrates “i”.

When the life span of the film stamp comes to an end and needs to be replaced, the film stamp is wound toward the substrate collecting roll unit 120 by the operations of the substrate supply roll unit 110 and the substrate collecting roll unit 120, so a new flexible substrate “f” having no pattern, i.e., a new film, may be inserted into the in-feed roll module 140 and the out-feed roll module 150. Accordingly, the film stamp process A may be formed on the new film to form a new stamping pattern, so the imprint process of forming a pattern on the substrate “i” by using the stamping pattern may be performed.

The stamping process A of forming a stamping pattern on the flexible substrate “f” and the imprint process B of forming a pattern on the substrate “i” according to the present exemplary embodiment includes coating resins r1 or r2 on the stamp master “s” or the substrate “i” arranged on the stage 200, moving a predetermined section of the flexible substrate “f” toward the stage 200 by the roll-to-roll unit 100 to be arranged on the stamp master “s” or the substrate “i”, pressing the predetermined section of the flexible substrate “f” toward the stamp master “s” or the substrate “i” by the stamping pressing unit 300 to contact the stamp master “s” or the substrate “i” and curing the resin r1 or r2 by using the UV lamp 500, thereby forming a stamping pattern on the flexible substrate “f” or a pattern on the substrate “i”, and separating the flexible substrate “f” from stamp master “s” or the substrate “i” by removing the pressing of the flexible substrate “f” by the stamping pressing unit 300. The protection film P to protect the surface of the flexible substrate “f” may be attached on the surface of the flexible substrate “f” during the stamping process A. The protection film P may be removed when the flexible substrate “f” is released from the substrate supply roll unit 110.

The stamping process A of forming a stamping pattern on the flexible substrate “f” is described in detail with reference to FIGS. 2A-2D. As illustrated in FIG. 2A, a predetermined section of the flexible substrate “f” is moved over the stage 200 by the substrate supply roll unit 110 and the substrate collecting roll unit 120 of the roll-to-roll unit 100 (refer to FIG. 1). The predetermined area of the flexible substrate “f” is in a state in which the stamping pattern is not formed yet.

As illustrated in FIG. 2B, the resin r1 is coated on the stamp master “s”. The coating of the stamp master “s” with the resin r1 is performed by the coating unit 400 that is spaced apart from the stage 200.

As illustrated in FIG. 2C, the stage 200 supporting the stamp master “s” coated with the resin r1 is moved such that the stamp master “s” is located directly under the predetermined area of the flexible substrate “f”. The predetermined area of the flexible substrate “f” is pressed toward the stamp master “s” by the stamping pressing unit 300 and the resin r1 is cured by the UV lamp 500. Accordingly, the stamping pattern is formed on the flexible substrate “f”.

While the flexible substrate “f” is pressed, the other area of the flexible substrate “f” connected to the substrate collecting roll unit 120 may be moved toward the stage 200. While being pressed by the stamping pressing unit 300, the predetermined area of the flexible substrate “f” is supported in an elastically biased state by the return support module 160 (refer to FIG. 160) and thus the same tension may be maintained in the predetermined area of the flexible substrate “f”.

As illustrated in FIG. 2D, when the pressing of the flexible substrate “f” by the stamping pressing unit 300 is removed, the other area of the flexible substrate “f” is returned and thus the flexible substrate “f” may be separated from the stamp master “s”. When a new stamping pattern is to be formed at a position spaced apart from the stamping pattern of the flexible substrate “f”, the roll-to-roll unit 100 (refer to FIG. 1) winds the flexible substrate “f” by a predetermined distance to form a new stamping pattern on a new surface of the flexible substrate “f”.

The imprint process B of forming a pattern on the substrate “i” is described in detail with reference to FIGS. 3A-3D. As illustrated in FIG. 3A, a predetermined section of the flexible substrate “f”, i.e., a film stamp, is moved over the stage 200 by the substrate supply roll unit 110 and the substrate collecting roll unit 120 of the roll-to-roll unit 100. A stamping pattern is formed in the predetermined area of the flexible substrate “f”.

As illustrated in FIG. 3B, the surface of the substrate “i” is coated with resin r2. The coating of the substrate “i” with the resin r2 is performed by the coating unit 400 that is spaced apart from the stage 200.

As illustrated in FIG. 3C, the stage 200 supporting the substrate “i” having the surface coated with the resin r2 is moved to be located directly under the predetermined area of the flexible substrate “f”. The predetermined area of the flexible substrate “f” is pressed toward the substrate “i” by the stamping pressing unit 300 and the resin r2 is cured by the UV lamp 500. Accordingly, the pattern is formed on the substrate “i”.

As illustrated in FIG. 3D, when the pressing of the flexible substrate “f” by the stamping pressing unit 300 is removed, the other area of the flexible substrate “f” is returned and thus the flexible substrate “f” may be separated from the substrate “i”. During the imprint process, when the stamping pattern is to be replaced by another new stamping pattern while a process of forming a pattern to the surface of the substrate “i” is performed to some degree, the roll-to-roll unit 100 winds the flexible substrate “f” so that the new stamping pattern may be disposed directly above the stage 200 where the imprint process is performed. Accordingly, the flexible substrate “f” where the stamping pattern is formed, i.e., a film stamp, may be easily replaced.

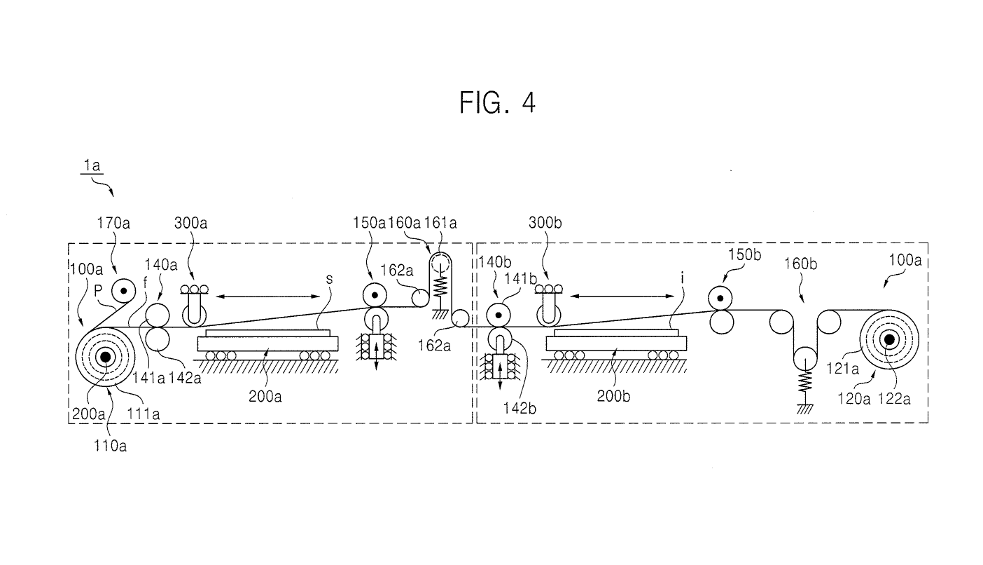

FIG. 4 illustrates a schematic view of a large-scale imprint apparatus 1a according to another exemplary embodiment. Referring to FIG. 4, the large-scale imprint apparatus 1a according to the present exemplary embodiment may continuously perform the stamping process A of forming a stamping pattern on the flexible substrate “f” and the imprint process B of forming a pattern on the substrate “i” by using a single roll-to-roll unit 100a. Accordingly, a time to replace the flexible substrate “f” where the stamping pattern is formed, i.e., a film stamp, may be remarkably reduced compared to the conventional technology. The following description mainly discusses only different portions from the above-described exemplary embodiment for convenience of explanation.

Referring to FIG. 4, the large-scale imprint apparatus 1a according to the present exemplary embodiment includes the roll-to-roll unit 100a for winding or rewinding the flexible substrate “f”, a first stage 200a supporting the stamp master “s” where a master pattern for forming a stamping pattern on the flexible substrate “f” is formed, a first stamping pressing unit 300a pressing the flexible substrate “f” to allow the flexible substrate “f” and the stamp master “s” to contact each other, thereby forming the stamping pattern on a surface of the flexible substrate “f”, a second stage 200b supporting the substrate “i” that contacts the flexible substrate “f” where the stamping pattern is formed so that a pattern is formed on the surface of the substrate “i”, and a second stamping pressing unit 300b pressing the flexible substrate “f” to allow the flexible substrate “f” and the substrate “i” to contact each other, thereby forming a pattern on the surface of the substrate “i”.

The stamping process A of forming a stamping pattern on the flexible substrate “f” is performed by the first stage 200a and the stamping pressing unit 300a, whereas the imprint process B of forming a pattern on the substrate “i” is performed by the second stage 200b and the stamping pressing unit 300b.

In the stamping process A, the roll-to-roll unit 100a for continuously supplying and moving the flexible substrate “f”, the first stage 200a arranged on a movement path of the flexible substrate “f” and supporting the stamp master “s” that contacts the flexible substrate “f” and forms a pattern on the flexible substrate “f”, and the stamping pressing unit 300a provided on the movement path of the flexible substrate “f” to allow the flexible substrate “f” to contact the stamp master “s” and be separated from the stamp master “s” after a pattern is formed on the flexible substrate “f” are used. Resin (not shown) is coated on the stamp master “s” arranged on the first stage 200a and then the stamping pressing unit 300a presses the flexible substrate “f” toward the stamp master “s” so as to contact each other. In this state, the resin is cured and then the flexible substrate “f” is separated from the stamp master “s”, thereby forming the stamping pattern on the flexible substrate “f”.

In the present exemplary embodiment, since a first in-feed roll module 140a, a first out-feed roll module 150a, and a first return support module 160a are similar to those of the above-described exemplary embodiment, detailed descriptions thereof will be omitted herein. However, since a first return support roller 161a of the first return support module 160a is different from the above-described exemplary embodiment, the first return support roller 161a will be mainly discussed in detail below.

The first return support roller 161a of the first return support module 160a according to the present exemplary embodiment supports the flexible substrate “f” by using air to prevent the stamping pattern surface of the flexible substrate “f” from contacting the first return support roller 161a. In other words, a plurality of nozzles for supplying air are formed on the first return support roller 161a along the circumferential direction thereof. Accordingly, an area of the flexible substrate “f” where the stamping pattern is formed, i.e., a film stamp area, may be moved without contacting the first return support roller 161a toward the second stage 200b where an imprint process is performed. When the film stamp is moved to the second stage 200b, the movement of the flexible substrate “f” is stopped and a middle in-feed roll module 140b and a second out-feed roll module 150b restrict the flexible substrate “f” to maintain a tension.

In the present exemplary embodiment, a second separation support unit (not shown) includes the middle in-feed roll module 140b that guides the movement of the flexible substrate “f” from the first stage 200a where the stamping process A is performed to the second stage 200b where the imprint process B is performed.

The middle in-feed roll module 140b corresponds to the first in-feed roll module 140a of a first separation support unit (not shown), but there is a difference between the first and second separation support units. In other words, the middle in-feed roll module 140b includes an upper in-feed roller 141b and a lower in-feed roller 142b that is arranged to face the upper in-feed roller 141b with the flexible substrate “f” interposed therebetween and to be capable of accessing and being separated from the upper in-feed roller 141b to be spaced apart from the stamping pattern of the flexible substrate “f”.

Accordingly, the flexible substrate “f” with the stamping pattern may be moved toward the second stage 200b for the imprint process B in a manner in which the stamped surface of the flexible substrate “f” may not contact the lower in-feed roller 142b by separating the lower in-feed roller 142b from the upper in-feed roller 141b. When the stamped flexible substrate “f” is transferred to the second stage 200b for the imprint process B, the imprint process may be performed, during which the stamping process A may be performed on the first stage 200a for the film stamp process.

In the imprint process B, the second stage 200b supporting the substrate “i” contacting the flexible substrate “f” with the stamping pattern so that a pattern is transferred to the substrate “i”, and the second stamping pressing unit 300b pressing the flexible substrate “f” toward the substrate “i”, are used. The flexible substrate “f” with the stamping pattern is pressed toward the substrate “i” where resin (not shown) is coated by the second stamping pressing unit 300b. As the resin is cured by a UV lamp (not shown), a pattern may be formed on the substrate “i”.

In the present exemplary embodiment, since the second out-feed roll module 150b and a second return support module 160b are similar to those in the above-described exemplary embodiment, detailed description thereof will be omitted herein. However, in the present exemplary embodiment, the second out-feed roll module 150b may not need a roller drive unit.

As described above, the large-scale imprint apparatus and method according to embodiments may embody uniform nano patterning, may enable mass production, and may facilitate handling and replacement of a film stamp, in spite of existence of surface unevenness, foreign materials on a surface, surface roughness, etc.

In contrast, since the nano imprint technology is a physical contact-based process, the conventional nano imprint technology may have the following problems when a contact surface increases.

First, when a contact area increases, a pressing force for imprint, as well as a demolding force to detach a stamp from a substrate, needs to be increased. Accordingly, the stamp or substrate may be damaged or particle defect may be generated as a result of the increased force.

Second, since neither the stamp nor the substrate has a perfect flat surface, the surface of the stamp or substrate may have an unevenness or a defect, thereby causing the stamp and the substrate to be not perfectly parallel to each other. Accordingly, an uneven residual layer may affect a subsequent process, and thus, the dimensions of a pattern may be changed.

Third, the stamp and the substrate are generally formed of different materials, and accordingly, have different thermal expansion coefficients. As the dimensions of the stamp and the substrate may be changed due to heat generated during an imprint process, the substrate and a template may be curved in a large scale process.

Fourth, when a large area is to be contacted, air bubbles may be collected between the stamp and the substrate. Therefore, defects may be generated between the stamp and the substrate.

Several attempts have been made to apply a stamp in a conventional large scale nano imprint process technology, i.e., when a surface contact increases. For example, in a step and flash method, a hard stamp corresponding to a relatively small area was used to perform imprinting, so a nano pattern could be imprinted in a large area by connecting small area imprints. In another example, a polymer stamp was used to perform the nano imprint process in order to minimize damage of a mold or a substrate during forming or detaching a large-scale nano imprint due to the ductility of the polymer stamp. In yet another example, a stamp (or master) filled with UV curable liquid polymer was contacted with a transparent and flexible substrate, followed by UV-curing and detaching from the stamp (or master) to form a rigid nano pattern on the flexible substrate. In still another example, a mold in a form of a tension-applied belt was used in a nano imprint process with respect to a large area beyond a surface-to-surface contact, since the belt type mold has a strong point in sequentially contacting and detaching of a substrate coated with UV curable polymer.

In other words, in order to conventionally pattern a nano pattern in a large area by using nano imprint, a nano imprint may be stamped in a small area and the small area imprints are connected to each other, an intermediate polymer stamp may be manufactured, or a pattern may be formed in a flexible film. However, while the intermediate polymer stamp method, the rigid-flex mold method, and the belt mold method using a flexible polymer film may partially perform nano patterning, they may be unsuccessful in mass production.

First, it may be difficult to handle a film stamp. In other words, it may be difficult to allow the film stamp to sequentially contact a target substrate, press the film stamp against the target substrate, and detach the film stamp from the target substrate. Since the film has no particular shape and may be easily bent or deformed, a window frame is provided at the outer edge of the film to handle the film. Accordingly, since an operator or equipment is needed in order to manufacture the film stamp or install the window frame, mass production may be restricted. Furthermore, the window frame may inconvenience sequentially contacting or detaching the film stamp with respect to the target substrate.

Second, it may be difficult to replace a belt type film mold. In order to replace the belt type film mold, a belt is disassembled and a new belt is wound. However, in doing so, a change in tension may affect process variation.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A large-scale imprint apparatus, comprising:
a roll-to-roll unit configured to wind or rewind a flexible substrate;
a stage arranged adjacent to a winding path of the flexible substrate, the stage being configured to support a stamp master with a master pattern or to support a substrate; and
a stamping pressing unit arranged adjacent to the stage, the stamping pressing unit being configured to press the flexible substrate against the stamp master or against the substrate.

2. The large-scale imprint apparatus as claimed in claim 1, wherein:
the stage supports the substrate,
the stamping pressing unit presses the flexible substrate toward the substrate to form a pattern on a surface of the substrate, and
the roll-to-roll module winds the flexible substrate when a stamping pattern on the flexible substrate is replaced with another stamping pattern.

3. The large-scale imprint apparatus as claimed in claim 1, wherein:
the stage supports the stamp master,
the stamping pressing unit presses the flexible substrate toward the stamp master to form a stamping pattern on a surface of the flexible substrate, and
the roll-to-roll module winds the flexible substrate when the stamping pattern is formed at a position spaced apart from the stamping pattern of the flexible substrate.

4. The large-scale imprint apparatus as claimed in claim 1, wherein the stamping pressing unit includes:
a flexible substrate pressing unit above the stage, the flexible substrate pressing unit being configured to allow the flexible substrate to contact the stamp master or the substrate; and
a sequential contact guide unit guiding the flexible substrate pressing unit to allow the flexible substrate to sequentially contact the stamp master or the substrate.

5. The large-scale imprint apparatus as claimed in claim 4, wherein the flexible substrate pressing unit includes a pressing roller configured to press the flexible substrate to allow the flexible substrate to sequentially contact the stamp master or the substrate.

6. The large-scale imprint apparatus as claimed in claim 5, wherein the sequential contact guide unit includes:
a roller moving module moving the pressing roller along the flexible substrate; and
a guide rail coupled to the pressing roller, the guide rail being movable.

7. The large-scale imprint apparatus as claimed in claim 5, wherein the roll-to-roll unit includes:
a substrate supply roll unit around which the flexible substrate is wound; and
a substrate collecting roll unit spaced apart from the substrate supply roll unit and winding or rewinding the flexible substrate with the substrate supply roll unit.

8. The large-scale imprint apparatus as claimed in claim 7, wherein the roll-to-roll unit further comprises a separation support unit between the substrate supply roll unit and the substrate collecting roll unit, the roll-to-roll unit supporting the flexible substrate to be spaced apart from the stamp master or the substrate.

9. The large-scale imprint apparatus as claimed in claim 8, wherein the separation support unit includes:
an in-feed roll module guiding a movement of the flexible substrate from the substrate supply roll unit to the stamping pressing unit; and
an out-feed roll module above the stage and guiding the flexible substrate toward the substrate collecting roll unit by supporting the flexible substrate to be spaced apart from the stamp master or the substrate.

10. The large-scale imprint apparatus as claimed in claim 9, wherein the out-feed roll module includes:
a first separation support roller supporting an upper surface of the flexible substrate; and
a second separation support roller between the first separation support roller and the flexible substrate to be capable of accessing and being separated from first separation support roller,
wherein the first separation support roller rotates to maintain a constant tension with respect to the flexible substrate even when the flexible substrate is moved in a pressing direction of the pressing roller while the pressing roller presses the flexible substrate toward the stamp master or the substrate.

11. The large-scale imprint apparatus as claimed in claim 9, wherein the separation support unit further comprises a return support module that supports the flexible substrate in an elastically biased state when the stamping pressing unit presses the flexible substrate to move toward the stamp master or the substrate.

12. The large-scale imprint apparatus as claimed in claim 11, wherein the return support module includes:
a return support roller configured to move from a normal position to a pressing position, while the stamping pressing unit presses the flexible substrate toward the stamp master or the substrate;
a plurality of support guide rollers adjacent to the return support roller and guiding a movement of the flexible substrate; and
an elastic member coupled to the return support roller and providing an elastic force to return the return support roller to the normal position.

13. The large-scale imprint apparatus as claimed in claim 7, wherein the roll-to-roll unit further comprises a protection film removing unit adjacent to the substrate supply roll unit, the protection film removing unit being configured to remove a protection film of the flexible substrate pulled from the substrate supply roll unit.

14. The large-scale imprint apparatus as claimed in claim 1, wherein the stage is configured to move from a coating position, where resin is coated on the stamp master or the substrate, toward the stamping pressing unit, a coating unit for coating the resin being positioned at the coating position.

15. A large-scale imprint apparatus, comprising:
a roll-to-roll unit configured to wind or rewind a flexible substrate;
a first stage adjacent to a winding path of the flexible substrate and supporting a stamp master with a master pattern;
a first stamping pressing unit adjacent to the first stage and configured to press the flexible substrate toward the stamp master, such that the master pattern is formed on a surface of the flexible substrate;
a second stage spaced apart from the first stage and supporting a substrate, the substrate being configured to contact the surface of the flexible substrate with the master pattern; and
a second stamping pressing unit adjacent to the second stage and configured to press the flexible substrate toward to contact each other and to transfer the master pattern from the flexible substrate to the substrate.

16. The large-scale imprint apparatus as claimed in claim 15, wherein the roll-to-roll unit winds the flexible substrate when the stamping pattern is replaced.

17. The large-scale imprint apparatus as claimed in claim 15, wherein:
the first stamping pressing unit includes:
a first flexible substrate pressing unit above the stage and allowing the flexible substrate to sequentially contact the stamp master, and
a first sequential contact guide unit guiding the first flexible substrate pressing unit to allow the flexible substrate to sequentially contact the stamp master; and
the second stamping pressing unit includes:
a second flexible substrate pressing unit above the stage and allowing the flexible substrate to contact the substrate, and
a second sequential contact guide unit guiding the second flexible substrate pressing unit to allow the flexible substrate to sequentially contact the substrate.

18. The large-scale imprint apparatus as claimed in claim 15, wherein the roll-to-roll unit includes:
a first separation support unit between the substrate supply roll unit and the substrate collecting roll unit and supporting the flexible substrate to be spaced apart from the stamp master; and
a second separation support unit between the substrate supply roll unit and the substrate collecting roll unit and supporting the flexible substrate to be spaced apart from the substrate.

19. The large-scale imprint apparatus as claimed in claim 18, wherein the second separation support unit is between the first stage and the second stage and includes a middle in-feed roll module that guides a movement of the flexible substrate to the second stage.

20. A large-scale imprint method, comprising:
coating resin on a substrate supported on a stage; and
forming a pattern on a surface of the substrate by pressing a flexible substrate toward the substrate, the flexible substrate being configured to wind and rewind.

21. The large-scale imprint method as claimed in claim 20, wherein forming the pattern on the surface of the substrate includes:
pressing the flexible substrate toward the substrate to allow the flexible substrate to sequentially contact the substrate; and
curing the resin.

22. The large-scale imprint method as claimed in claim 20, further comprising winding the flexible substrate when the stamping pattern is replaced.

23. A large-scale imprint method, comprising:
coating resin on a flexible substrate; and
forming a stamping pattern on a surface of the flexible substrate by pressing the flexible substrate against a stamp master with a master pattern, the flexible substrate being configured to wind and rewind.

24. The large-scale imprint method as claimed in claim 23, wherein forming the stamping pattern on the surface of the flexible substrate includes:
pressing the flexible substrate by using the stamp master to allow the flexible substrate to sequentially contact the stamp master; and
curing the resin.

25. The large-scale imprint method as claimed in claim 23, further comprising winding the flexible substrate when the stamping pattern is newly formed.

26. A large-scale imprint apparatus, comprising:
a roll-to-roll unit configured to wind or rewind a flexible substrate;
a first stage arranged below a winding path of the flexible substrate, the first stage being configured to support a stamp master or a substrate; and
a first stamping pressing unit above the first stage and above the winding path of the flexible substrate, the stamping pressing unit being configured to press the flexible substrate against the stamp master or the substrate.

27. The large-scale imprint apparatus as claimed in claim 26, wherein the first stamping pressing unit includes:
a flexible substrate pressing unit above the stage; and
a sequential contact guide unit configured to move along the flexible substrate while pressing the flexible substrate against the stamp master or the substrate.

28. The large-scale imprint apparatus as claimed in claim 26, wherein the roll-to-roll unit includes:
a substrate supply roll unit around which the flexible substrate is wound;
a substrate collecting roll unit spaced apart from the substrate supply roll unit and winding or rewinding the flexible substrate with the substrate supply roll unit; and
a separation support unit between the substrate supply roll unit and the substrate collecting roll unit, the separation support unit including a return support module configured to support the flexible substrate in an elastically biased state.

29. The large-scale imprint apparatus as claimed in claim 26, wherein the stage is moveable from a first position to a second position, the first position being below the first pressing unit and second position being below a coating unit.

30. The large-scale imprint apparatus as claimed in claim 26, further comprising:
a second stage spaced apart from the first stage and supporting the substrate, the substrate being configured to contact a surface of the flexible substrate with a master pattern; and
a second stamping pressing unit above the second stage and configured to press the flexible substrate against the substrate,
wherein the first stage supports only the stamp master and the first stamping pressing unit is configured to press the flexible substrate only against the stamp master.
